(19) United States
(12) Patent Application Publication
(10) Pub. No.: US 2015/0356580 A1
(43) Pub. Date: Dec. 10, 2015

(54) SYSTEM FOR FACILITATING COLLECTION OF INFORMATION ABOUT PRODUCTS

(71) Applicant: TOSHIBA TEC KAUBSHIKI KAISHA, Tokyo (JP)

(72) Inventor: Ryotaro KOBAYASHI, Izunokuni Shizuoka (JP)

(21) Appl. No.: 14/733,886

(22) Filed: Jun. 8, 2015

(30) Foreign Application Priority Data
Jun. 9, 2014 (JP) 2014-118689

(51) Int. Cl. G06Q 30/02

(52) U.S. Cl. CPC G06Q 30/0203

(57) ABSTRACT

A system for collecting information about a plurality of products includes first and second servers. The first server stores each of surveys in correlation with a product ID and one or more completed surveys, and is configured to respond to a survey request with a survey corresponding to a product ID included therein. The second server is configured to receive and store electronic receipt data generated by the store servers in connection with purchase transactions of products, and transmit electronic receipt data of a first type that includes a link to a survey stored in the first server. The first server receives completed surveys transmitted from each of the mobile computing devices that received the electronic receipt data of the first type, accessed one of the surveys stored in the first server through the link, and then indicated completion of the survey.

### CROSS-REFERENCE TO RELATED APPLICATION

This application is based upon and claims the benefit of priority from Japanese Patent Application No. 2014-118689, filed Jun. 9, 2014, the entire contents of which are incorporated herein by reference.

### FIELD

Embodiments described herein relate generally to a system for facilitating collection of information about products.

### BACKGROUND

In the related art, an electronic receipt system transmits electronic data of a purchase transaction at a store (i.e., an electronic receipt) to a computing device of a customer, such as a mobile device, instead of a conventional paper receipt that is handed to the customer upon completion of the purchase transaction. Then, the customer can view the electronic receipt on a display unit of the computing device.

Today, manufacturers or retailers of products conduct surveys to acquire customers' opinions and questions about the products. Conventionally, these surveys are individually conducted by each of the manufacturers or retailers, through their websites or communication by email or mail. A more effective way to facilitate the collection of survey information would be desirable.

### DESCRIPTION OF THE DRAWINGS

FIG. 1 is a block diagram of an entire electronic receipt system according to an embodiment.

FIG. 2 is a block diagram of an electronic receipt management server.

FIG. 3 illustrates data structure of a survey management table stored in the electronic receipt management server.

FIG. 4 is a flow diagram illustrating a registration process to the survey management table.

FIG. 5 is a flow diagram illustrating a transmission process of an electronic receipt from the electronic receipt management server.

FIG. 6 is a flow diagram illustrating a transmission and reception process of a survey input form from the electronic receipt management server.

FIG. 7 is a block diagram of a form data management server in the electronic receipt system.

FIG. 8 illustrates survey management tables stored in the form data management server.

FIG. 9 illustrates a survey result management table stored in the form data management server.

FIG. 10 illustrates an example of an input form for a survey.

FIG. 11 is a flow diagram illustrating a registration process of a question carried out by the form data management server.

FIG. 12 is a flow diagram illustrating a notification process carried out by the form data management server.

FIG. 13 is a flow diagram illustrating a search process of the question and the like carried out by the form data management server.

FIG. 14 is a flow diagram illustrating a registration process of a response and the like carried out by the form data management server.

FIG. 15 is a block diagram of a customer terminal in the electronic receipt system.

FIGS. 16A and 16B illustrate screen transition of screens displayed on the customer terminal.

### DETAILED DESCRIPTION

In general, according to one embodiment, a system includes at least first and second servers for collecting information about a plurality of products. The first server stores a plurality of surveys and correlates each of the surveys to a product ID and one or more completed surveys, and is configured to respond to a survey request with a survey corresponding to a product ID included in the survey request. The second server is networked to a plurality of store servers and a plurality of mobile computing devices of users. The second server is configured to receive and store electronic receipt data generated by the store servers in connection with purchase transactions of products, and to transmit electronic receipt data of a first type that includes a link to a survey stored in the first server and electronic receipt data of a second type that does not include the link. The first server receives completed surveys transmitted from each of the mobile computing devices that received the electronic receipt data of the first type, accessed one of the surveys stored in the first server through the link, and then indicated completion of the survey.

There is a system called an electronic receipt system that provides an electronic receipt to a customer terminal that is a terminal device of a customer instead of a paper receipt when the customer registers membership.

The description below illustrates an example in which a form data management server (survey server) is disposed in the electronic receipt system, and a server apparatus according to the present embodiment is applied to an electronic receipt management server. In addition, the description illustrates an example in which a survey collection system is built by the electronic receipt management server and the form data management server.

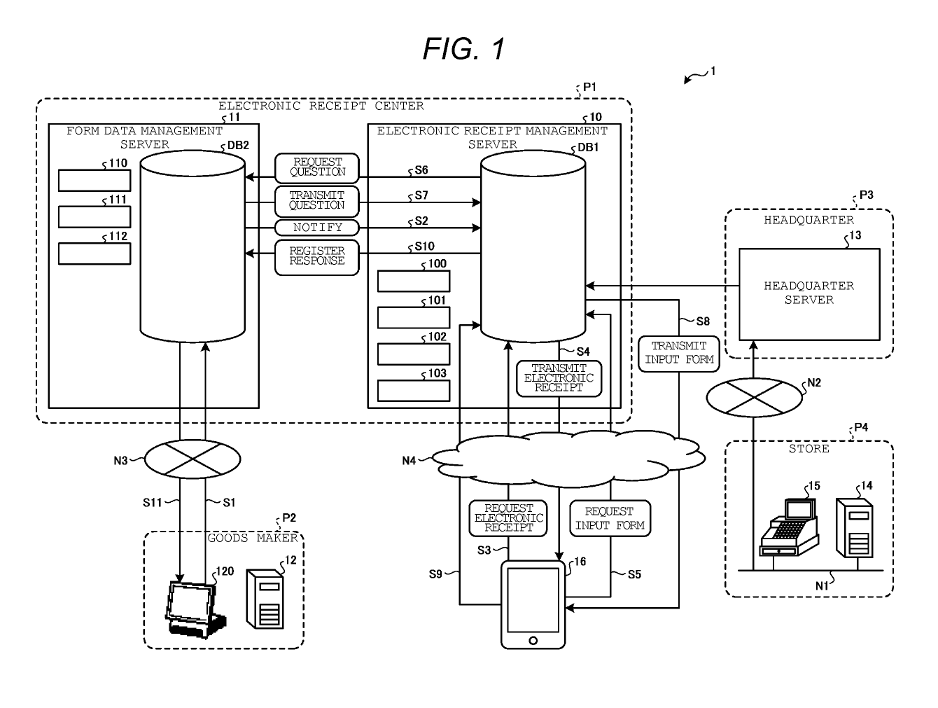

FIG. 1 illustrates an entire configuration of the electronic receipt system according to an embodiment.

As illustrated in FIG. 1, an electronic receipt system 1 includes an electronic receipt management server 10, a form data management server 11, a consumer goods maker server 12 (input terminal 120), a headquarter server 13, a store server 14, a point of sale (POS) terminal 15, and a customer terminal 16.

The electronic receipt management server 10 is located in a third-party electronic receipt center P1. The electronic receipt management server 10 is a server apparatus that mainly manages electronic receipt information.

The form data management server 11 is also located in the electronic receipt center P1 in the same manner as the electronic receipt management server 10 according to the present embodiment. The form data management server 11 is a server apparatus that mainly manages survey (question and response) about merchandise. According to the present embodiment, the form data management server 11 also manages inquiry information about merchandise. Since management of the survey is mainly dealt herewith, the survey will be mainly described in the following description, and description of the inquire information will be supplemented when necessary.

The consumer goods maker server 12 is located in a consumer goods maker P2. The consumer goods maker server 12 is a server apparatus that manages information of merchandise produced by the consumer goods maker. The input terminal 120 is connected to the consumer goods maker server 12 as a client apparatus.

The headquarter server 13 is a server apparatus that is located in a headquarter P3 of a company (retailer) which operates one or more stores or chain stores.

The store server 14 is located in a store P4 of the company. The store server 14 is a server apparatus that manages all of the POS terminals 15 in the store P4.

The POS terminal 15 is a POS terminal located in the store P4. A plurality of POS terminals may be located in the store P4.

The customer terminal 16 is a terminal device that a customer uses at home or outside home.

The electronic receipt management server 10 is a server apparatus that manages electronic receipts, which are received from the headquarter servers 13 of multiple companies. The electronic receipt management server 10 receives electronic receipts in variety of formats from the headquarter servers 13, associates each electronic receipt with a company code, and manages the electronic receipts collectively in a database DB1.

The electronic receipt management server 10 has an electronic receipt transmitting unit (not illustrated). When a transmission request for an electronic receipt is received from the customer terminal 16, the electronic receipt management server 10 transmits (delivers) a corresponding electronic receipt to the customer terminal 16.

The electronic receipt management server 10 further has a survey button transmitting section 100 as a section that embeds an operation button in an electronic receipt to be transmitted.

The survey button transmitting section 100 is operates so that the customer terminal 16 displays an electronic receipt including an operation button that corresponds to target merchandise for which a survey is conducted (survey conducting merchandise) and is operable by a user.

More specifically, the survey button transmitting section 100, in one aspect thereof, operates such that the customer terminal 16 displays an electronic receipt with a survey button attached thereto when merchandise in the electronic receipt is a target of a survey. The survey button is, for example, an icon and the like. When the user touches (selects) the survey button on screen, a selection signal of the survey button is output. Alternative to the survey button displayed, the function to generate the selection signal may be allocated to a mechanical switch of a user terminal.

Here, the electronic receipt is transmitted after being appropriately converted into a format determined based on the environment of the customer terminal 16 (for example, a difference between a smart phone and a tablet terminal).

The electronic receipt management server 10 further includes an extracting section (question information extracting section) 101, an input form transmitting section (survey transmitting section) 102, and a registering section (response information registering section) 103.

The extracting section 101, when the selection signal of the survey button (that is, an operation signal of the operating unit) is received from the customer terminal 16 after the electronic receipt has been transmitted, extracts the question information (information that indicates classifications of inquiry) of questions (or classifications of inquiry), which are to be displayed on the survey (or inquiry) input form, from the form data management server 11. “Classifications of inquiry” means the classification of the inquiries classified based on content thereof. For example, when the merchandise is a device, inquiries will be “inquiries about how to use the device”, “inquiries about a trouble of the device”, and the like.

The input form transmitting section 102 operates such that the input form including the question (or the information that indicates classifications of inquiry) is extracted from the form data management server 11 is transmitted to the customer terminal 16.

The input form transmitting section 102, upon receiving the selection signal of the survey button from the customer terminal 16, operates such that a selection screen that includes two selection items of “participate in survey” and “inquiries” is transmitted to the customer terminal 16 when the inquired merchandise is target merchandise of a survey. In this case, the input form transmitting section 102 operates to transmit an input form including the question to the customer terminal 16 in response to receiving the selection signal of “participate in survey” on the selection screen. In addition, the input form transmitting section 102 operates to transmit an input form including a classification of the inquiry extracted from the form data management server 11 to the customer terminal 16 in response to receiving the selection signal of “inquiries.”

The registering section 103, when a response (or specific content of inquiry) of the customer about the questions (or classifications of inquiry) input in the input form is received from the customer terminal 16, registers the response (or specific content of inquiry) in the form data management server 11. Examples of the specific content of inquiry include “Please tell me how to turn on the power switch” when “the classification of inquiry is “inquiries about how to operate the machine”.

Here, the target merchandise of the survey and the target merchandise of the inquiry are examples of “input target merchandise” that requires input from the user. Therefore, the input target merchandise is not limited to these two examples and may be appropriately set as others such as “merchandise user registration.”

When the target merchandise of the survey and the target merchandise of the inquiry target merchandise are regarded as the input target merchandise, the extracting section 101 extracts information corresponding to the input target merchandise. In addition, the input form transmitting section 102 includes the information that corresponds to the input target merchandise in the input form. The input form transmitting section 102 also includes items that correspond to the input inquiry merchandise in the selection screen. The registering section 103 registers information input by the user with respect to the information about the input target merchandise, in the form data management server 11.

The form data management server 11 mainly manages the survey about merchandise. According to the present embodiment, the form data management server 11 also manages the inquiry information about merchandise. The form data management server 11 associates questions (or information that indicates classifications of inquiry) in a survey that is provided online or offline from each consumer goods maker with merchandise identification information (mainly merchandise code), and collectively manages the question information in a database DB2. Furthermore, the form data management server 11 associates the response that is input through the customer terminal 16 in response to the question information (or specific content of the inquiry by the customer), and collectively manages the responses in the database DB2.

The form data management server 11 further includes a provided information registering section (information registering and notifying section) 110, an extracting section (information extracting and transmitting section) 111, and a response information registering section (information registering section) 112.

The provided information registering section 110 registers the merchandise question information (or the information that indicates classifications of inquiry) that is provided from the consumer goods maker, in the database DB2.

The form data management server 11, when the question information is registered in the database DB2, operates to notify the electronic receipt management server 10 that a survey of the corresponding merchandise has been conducted.

The extracting section 111 extracts specified question information (or information indicating classifications of inquiry) from the database DB2 and operates to transmit the question information to the electronic receipt management server 10.

The response information registering section 112 registers the response (or information that indicates the specific content of the inquiry) that is transmitted from the electronic receipt management server 10, in the database DB2.

The consumer goods maker server 12 is a server apparatus of a maker producing merchandise having the standardized codes. As standardized codes, Japanese Article Number (JAN) codes are used in Japan. In addition, European Article Number (EAN) codes are used in Europe and the like, and the Universal Product Code (UPC) is used in the United States. Here, it is assumed that the consumer goods maker server 12 manages merchandise information using the JAN codes.

The headquarter server 13 has a database (not illustrated) to collectively manages merchandise sales data, which indicates the content of a purchase transaction carried out at the POS terminal 15 in a store P4 of the company. In the database, the merchandise information, purchase history information including the electronic receipt information, and the like are registered.

The merchandise information includes, for example, merchandise code, name, and price of merchandise.

The purchase history information includes, for example, a member code of a customer and content of a purchase transaction by the customer in the store P4. The content of the purchase transaction includes, for example, transaction date and time, name of the store, the merchandise code of purchased merchandise, merchandise name, and total price, and at least some of these are included in the receipt information.

When a purchase transaction is completed at the POS terminal 15 in each store P4, an electronic receipt corresponding to the purchase transaction is issued and transmitted to the headquarter server 13 via the store server 14.

The headquarter server 13 registers the electronic receipt in the database and manages electronic receipts with respect to each member.

The store server 14 manages merchandise sales data processing that is performed at one or more POS terminals 15. The store server 14 stores and manages merchandise data files used in querying merchandise at the POS terminal 15. The store server 14 also stores and manages the customer merchandise sales data obtained through the merchandise sales data processing.

The store server 14 also synchronizes data with the headquarter server 13 by accessing the headquarter server 13 regularly. For example, the store server 14 downloads the most recent merchandise information from the headquarter server 13 and uploads the customer merchandise sales data obtained through the merchandise sales processing, to the headquarter server 13.

The POS terminal 15 processes the merchandise sales data in an interactive manner with a customer. This process is performed per one purchase transaction by one customer. For example, when a casher scans the merchandise to be purchased by the customer with a reading device such as a scanner, the POS terminal 15 queries the identified merchandise to the merchandise data files in the store server 14, processes payment when all merchandise to be purchased is confirmed, and ends one transaction with a cut command. The POS terminal 15 performs a process of asking the customer (member) whether to issue the electronic receipt for the purchase transaction, for example, by displaying a confirmation button on a display screen. When the customer shows an intention to issue the electronic receipt during this process, the POS terminal 15 operates to scan a member code of the customer through a reading device such as a camera, a barcode scanner, or a card reader.

The POS terminal 15 converts the receipt information of one transaction, which is fixed by the cut command, into the electronic receipt according to predetermined conditions and into a predetermined format of the company. The conditions and the format of the conversion include, for example, price range and a type of the merchandise, which are used as a criteria for listing merchandise in the electronic receipt.

The POS terminal 15, after payment has been confirmed, uploads the merchandise sales data (electronic receipt) of one purchase transaction by the customer to the store server 14. When the member code of the customer is obtained, the POS terminal 15 includes the member code in the electronic receipt.

The customer terminal 16 is an information processing device such as a smart phone, a tablet terminal, or a personal computer. A mobile terminal such as a smart phone or a tablet terminal will be exemplified as the POS terminal 15 in the following description of the present embodiment.

The customer terminal 16 includes a storage unit that stores the member code.

A member code is issued when the customer completes membership registration to the electronic receipt system 1. The member code is stored in an IC card, a magnetic card, or the storage unit of the customer terminal 16 carried by the customer. The member code may be stored in the storage unit as a code symbol such as a QR code (registered trademark) or a two-dimensional barcode, and encrypted. The customer, during the purchase transaction at the POS terminal 15, shows an intention to receive electronic receipts by presenting the member code so as to be scanned by a camera, a reader, or the like of the POS terminal 15.

The customer terminal 16 also includes an application program that manages the electronic receipt and subsidiary information, and displays the electronic receipt, the survey (or inquiry) input form, and the like on a display screen thereof. The customer terminal 16 accesses the electronic receipt management server 10 and transmits a password and the member code thereto. When the password and the member code are verified, the customer terminal 16 can download the electronic receipt, the survey (or inquiry) input form, and the like from the electronic receipt management server 10. The user specifying the transaction date and time, the transaction store, and the like, causes the application program to extract the electronic receipts that meet the condition from the electronic receipt management server 10. In addition, the application program operates to display the downloaded electronic receipt, the survey (or inquiry) input form, and the like on the display screen.

Examples of the application program include a Web browser. When a Web browser is used, HTTP communication is carried out with respect to the electronic receipt management server 10, and the electronic receipt and the input form are downloaded therefrom. The electronic receipt management server 10 starts a CGI and generates an input form and the like in response to a request from the Web browser, and transmits an HTML screen, the input form, and the like to the customer terminal 16. The application program is not limited to a Web browser, and other dedicated application programs may be alternatively used.

Each of the apparatuses 10 to 16 illustrated in FIG. 1 is configured to be connected to each other through a dedicated line, a public line, the Internet, or the like.

The POS terminal 15 is included in an in-store network (network N1) such as a local area network (LAN), along with the store server 14.

The headquarter server 13 is configured to be connected to the store server 14 through a dedicated line (network N2) such as a virtual private network (VPN).

The consumer goods maker server 12 is configured to be connected to the form data management server 11 through a dedicated line (network N3) such as a VPN. The input terminal 120 and the consumer goods maker server 12 are included in the same network such as an intracompany LAN.

The customer terminal 16 is connected to the electronic receipt management server 10 through the Internet (network N4). The customer terminal 16, for example, accesses a telephone network through a wireless base station, then the Internet through a packet communication network by using a control device of the wireless base station, and finally the electronic receipt management server 10 on the Web.

The electronic receipt management server 10 and the form data management server 11 are included in the same network such as a LAN, according to the present embodiment.

In addition, the electronic receipt management server 10 and the headquarter server 13 are included in the same network such as a VPN.

A survey collecting process using the electronic receipt system 1 is performed through the following procedure. The main difference between the flow of the survey collecting process and the flow of an inquiry process, which is additionally performed in the survey collecting process, is whether or not a selection screen is displayed on the customer terminal 16. In view of this, the following procedure illustrates the flow of the survey collecting process, and for the inquiry process, the flow of the process for the selection screen that is mainly different will be collectively described subsequently.

First, the survey question is input through the input terminal 120 of the consumer goods maker and transmitted from the input terminal 120 to the form data management server 11. Then, the survey question is registered in the database DB2 (S1). In this process, for example, a registration input form is displayed on a display screen of the input terminal 120, and a merchandise code of merchandise produced by the consumer goods maker and the question for a survey of the merchandise are input by a staff of the maker who is in charge thereof. The input merchandise code and the question are transmitted to the form data management server 11.

The provided information registering section 110 of the form data management server 11 associates the merchandise code with the question, which are transmitted from the consumer goods maker server 12, and registers the merchandise code and the question in the database DB2.

Next, the form data management server 11 notifies the electronic receipt management server 10 of activation of the registered survey. The electronic receipt management server 10, in response to the notification, associates information indicating the activation of the survey and the merchandise code, and registers the information and the merchandise code in the database DB1 (S2). The information indicating the activation of the survey indicates whether the merchandise is a target of the survey. This information is specified by, for example, a flag.

When the customer terminal 16 accesses the electronic receipt management server 10 that is in such a state, the following processes are performed.

First, the customer terminal 16 accesses the electronic receipt management server 10 and requests transmission of an electronic receipt (S3).

The electronic receipt management server 10 transmits the electronic receipt requested by the customer terminal 16 to the customer terminal 16 with a survey button embedded to the electronic receipt (S4). In this process, for example, the electronic receipt is extracted from the database DB1 based on a member code of the customer, which is transmitted from the customer terminal 16 together with the request. Then, the survey button transmitting section 100 detects whether merchandise in the electronic receipt is a target of the survey, by referring to the information indicating whether the survey is to be conducted, which is stored in the database DB1. When the merchandise is the target, the electronic receipt with the survey button being embedded therein is transmitted to the customer terminal 16 that has transmitted the request.

The display screen of the customer terminal 16 displays the electronic receipt, and the survey button if the target merchandise is included in the electronic receipt. When the user (customer) of the customer terminal 16 (selects the survey button, the selection signal of the survey button is transmitted to the electronic receipt management server 10 as a request for the survey input form (S5).

When the electronic receipt management server 10 receives the request for the survey input form by the selection signal of the survey button, the extracting section 101 sends a request for the question information that is displayed on the survey input form to the form data management server 11 (S6).

In response to this request, the extracting section 111 of the form data management server 11 extracts the corresponding question from the database DB2 and transmits the question to the electronic receipt management server 10 (S7).

Next, the input form transmitting section 102 of the electronic receipt management server 10 transmits the input form including the question received from the form data management server 11 to the customer terminal 16 (S8).

As a result, the survey input form is displayed on the display screen of the customer terminal 16.

Next, when the user inputs a response to the question in the input form and transmits the response (S9), the registering section 103 of the electronic receipt management server 10 sends a request for registration of the response to the form data management server 11 (S10).

In response to this request, the response information registering section 112 of the form data management server 11 registers the response in the database DB2.

Then, the form data management server 11, when the response is requested from the input terminal 120 of the consumer goods maker, transmits the response to the consumer goods maker server 12 (S11).

The inquiry process is performed as follows. In step S2, for the merchandise that is both an inquiry target and a survey target, the form data management server 11 notifies the electronic receipt management server 10 that the merchandise is both the inquiry target and the survey target.

When the selection signal of the survey button is received from the customer terminal 16 in step S5, the electronic receipt management server 10 transmits a selection screen to the customer terminal 16 before step S6. The electronic receipt management server 10 performs the process of step S6 after receiving any selection signal of “participate in survey” and “inquiries” from the customer terminal 16. In step S6, the extracting section 101 sends a request for the question (or classifications of inquiry) displayed on the survey (or inquiry) input form to the form data management server 11.

Next, a detailed description will be provided for a configuration and operation of main apparatuses in the electronic receipt system 1.

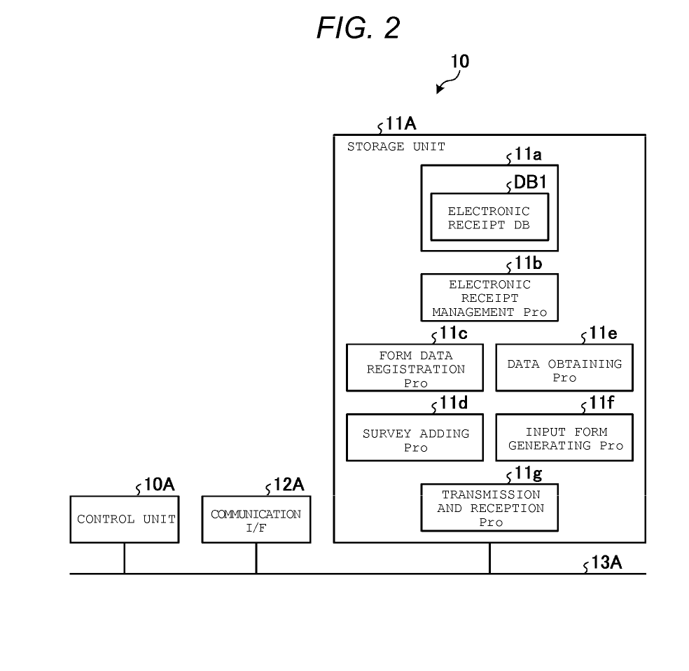

FIG. 2 is a block diagram of the electronic receipt management server 10. The electronic receipt management server 10 includes a control unit 10A, a storage unit 11A, and a communication I/F 12A. The control unit 10A, the storage unit 11A, and the communication I/F 12A are connected to each other through a bus 13A.

The control unit 10A is a computer that collectively controls each unit of the electronic receipt management server 10 and performs operation processing, data input and output control, and the like. The control unit 10A includes a central processing unit (CPU), a read-only memory (ROM) that stores various programs and data, a random access memory (RAM) as a working memory for loading various programs and storing data in a rewritable manner, a real-time clock (RTC) unit that indicates a current date and time, and the like.

The storage unit 11A is an auxiliary storage device such as a hard disk drive (HDD) or a solid-state drive (SSD). Various programs and data illustrated below are loaded in the RAM of the control unit 10A and are executed by the CPU to function as an electronic receipt managing section (not illustrated), the survey button transmitting section 100, the extracting section 101, the input form transmitting section 102, the registering section 103, and the like illustrated in FIG. 1.

The storage unit 11A includes a storage region 11a storing a database that manages electronic receipts, that is, the database DB1 (refer to FIG. 1). In addition, the storage unit 11A stores an electronic receipt management program 11b.

The database DB1 includes, for example, a survey management table to manage whether a survey is to be conducted with respect to merchandise included in the electronic receipt, in addition to an electronic receipt management table.

In the electronic receipt management table, electronic receipts are grouped based on company codes and member codes. A unique code (electronic receipt number) is assigned to each electronic receipt in the electronic receipt management table, as identifiable information, and the electronic receipts are managed using the electronic receipt numbers. The unique codes here are assigned to all electronic receipts in the electronic receipt management table, but may be assigned only to electronic receipts of a particular company code, a particular member, or the like. The electronic receipt number allows one electronic receipt to be specified, and therefore various kinds of information included in the electronic receipt and information correlated with the electronic receipt such as the sex and the age of the customer can be obtained.

The survey management table is a table to register and manage the information indicating activation of a survey, in response to the notification of the information from the form data management server 11.

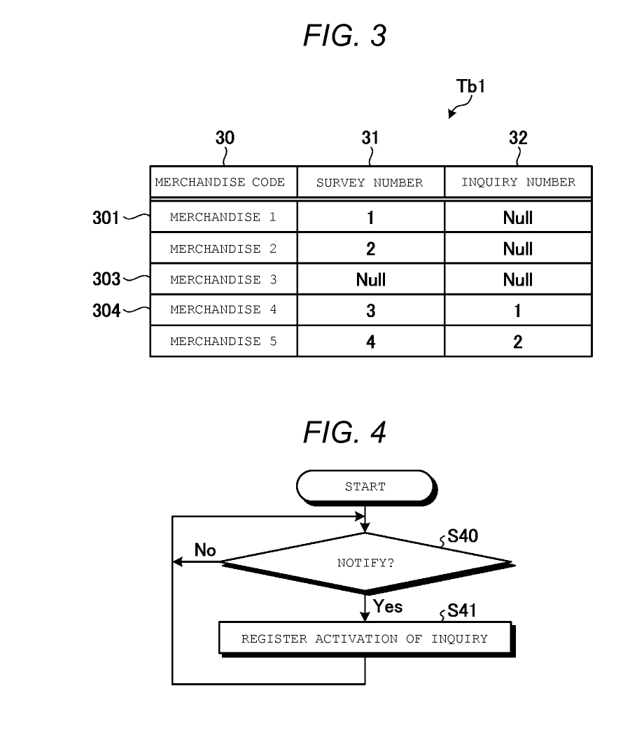

FIG. 3 illustrates an example of the survey management table.

A survey management table Tb1 in FIG. 3 includes “merchandise code” 30, “survey number” 31, and “inquiry number” 32 as main items (fields).

“Merchandise code” 30 is a field to stores a standardized code, which is a combination of numbers and alphabet characters and includes a code assigned to each consumer goods maker. In FIG. 3, the JAN code is used for a merchandise 1, a merchandise 2, and the like.

“Survey number” 31 is a field to store a serial number of a survey. In the present embodiment, “survey number” 31 stores 1, 2, 3, and the like as serial numbers and stores “Null” for merchandise for which a survey number has not been assigned.

“Inquiry number” 32 corresponds to an inquiry in the present embodiment. A serial number is assigned to each inquiry in the same manner as the survey, and “inquiry number” 32 is a field to store the serial number of an inquiry. In the present example, “inquiry number” 32 stores 1, 2, 3, and the like as a serial number and stores “Null” for merchandise for which an inquiry number has not been assigned.

The information stored in each field in the same row is correlated with each other.

Description returns to the configuration of the electronic receipt management server 10 in FIG. 2.

The electronic receipt management program 11b is executed to extract, register, update, and delete information in various tables stored in the database DB1 and manage such information.

A form data registration program 11c is executed to register a target merchandise code and the information indicating activation of the survey in the survey management table based on the notification of the information from the form data management server 11.

The form data registration program 11c will be specifically described using FIG. 3.

When notification of the information indicating activation of a survey with respect to “merchandise 1” is sent from the form data management server 11, a record 301 is registered in the survey management table Tb1. The record 301 illustrates a state where the survey number “1” and the inquiry number “Null” are set for the merchandise code “merchandise 1”.

Since the notification indicates activation of a survey for “merchandise 1”, the initial serial number “1” is registered as a survey number and is stored in “survey number” 31. Also, since the notification does not indicate activation of an inquiry for “merchandise 1”, “inquiry number” 32 is set to “Null.”

When the notification from the form data management server 11 indicates activation of an inquiry, an activation of the inquiry is also registered.

For example, a record 304 illustrates a state where the survey number “3” and the inquiry number “1” are set for the merchandise code “merchandise 4”. The number “3” that is continued from the serial number “2” of the merchandise 2 is registered as a survey number according to notification from the form data management server 11 and is stored in “survey number” 31. In addition, the initial serial number “1” is registered as an inquiry number and is stored in “inquiry number” 32.

A record 303 illustrates a state where the survey number “Null” and the inquiry number “Null” are set for the merchandise code “merchandise 3”. The record 303 may not necessarily be registered, but is illustrated for comparison with other states.

As described above, activation of a survey is registered by setting numbers other than “Null” in “survey number” 31 of the survey management table Tb1. In addition, activation of an inquiry is registered by setting numbers other than “Null” in “inquiry number” 32 of the survey management table Tb1. Other flags may also be used.

Description returns to the configuration of the electronic receipt management server 10 in FIG. 2.

A survey adding program 11d is a program that is executed when an electronic receipt for which a transmission request is received from the customer terminal 16 is transmitted to the customer terminal 16. The survey adding program 11d is executed to embed the survey button into the electronic receipt when a survey is activated for merchandise included in the electronic receipt. Determination of whether a survey is activated is carried out by, for example, a flag. Here, the determination is assumed to be made by setting numbers other than “Null” in “survey number” 31 of the survey management table Tb1.

A data obtaining program 11e is a program that is executed when the selection signal of the survey button is received from the customer terminal 16. The data obtaining program 11e is executed to obtain from the form data management server 11 the question to be displayed on the survey input form of the merchandise for which the survey button is selected. For example, the merchandise code of target merchandise is transmitted to the form data management server 11 as a transmission request for the question from the customer terminal 16, and the customer terminal 16 receives the question from the form data management server 11 as a response thereto .

An input form generating program 11f is a program to generate the survey input form. The input form generating program 11f is executed to locate the question obtained through the execution of the data obtaining program 11e at a predetermined position of the survey input form, and update the survey input form.

A transmission and reception program 11g is a program to transmit and receive data through the communication I/F 12A. The transmission and reception program 11g is executed to perform transmission and reception of data mainly with the form data management server 11, the customer terminal 16, and the headquarter server 13. When notification indicating activation of a survey is received from the form data management server 11, the transmission and reception program 11g is executed to request to register the activation of the survey through the form data registration program 11c. When the electronic receipt is received from the headquarter server 13, the transmission and reception program 11g is executed to request to register the electronic receipt through the electronic receipt management program 11b. When a transmission request for the electronic receipt is received from the customer terminal 16, the transmission and reception program 11g is executed to request to extract the electronic receipt through the electronic receipt management program 11b. In addition, the transmission and reception program 11g is executed to transmit the electronic receipt in which the survey button is embedded to the customer terminal 16 in response to the transmission request for the electronic receipt. When the selection signal of the survey button (that is, a request for the survey input form) is received from the customer terminal 16, the transmission and reception program 11g is executed to request to obtain the question information through the data obtaining program 11e. In addition, the transmission and reception program 11g is executed to transmit the survey input form to the customer terminal 16 in response to the selection signal. When input data on the survey input form is received from the customer terminal 16, the transmission and reception program 11g is executed to attach subsidiary information (the merchandise code, the electronic receipt number, and the like) to the input data and transmit the input data to the form data management server 11.

The communication I/F 12A is a communication interface that is connected to the network N4, the form data management server 11 which is on the same network, and the headquarter server 13.

FIG. 4 to FIG. 6 are flow diagrams of the survey collecting process performed by the electronic receipt management server 10. Each process illustrated below is performed by the CPU of the control unit 10A executing various programs stored in the storage unit 11A or supplementary programs and data. An initializing process and an ending process are omitted in FIG. 4 to FIG. 6. The ending process is desirably performed after the end of a series of processes. When ending a process at an appropriate timing, the ending process is assumed to notify processes that are related to each other and also end the related processes.

FIG. 4 is a flow diagram of a registration process in the survey management table Tb1 when notification of activating a survey is received from the form data management server 11.

First, it is determined whether notification of activating a survey is received from the form data management server 11 (S40). When notification is determined to not received in step S40 (determined as No), the determination is repeated until further notification is received.

When notification is determined as received in step S40 (determined as Yes), the information indicating activation of a survey of merchandise is registered in the survey management table Tb1 (S41).

In the process of step S41, one record is registered in the survey management table Tb1 based on merchandise and the information indicating the activation of a survey, which are both included in the notification from the form data management server 11. Specifically, when the merchandise code of the merchandise is “merchandise n (where n is a natural number)”, a record of “n” as the merchandise code 30, an unassigned serial number as the survey number 31, and “Null” as the inquiry number 32 is Null is registered. The process returns to step S40 after step S41. Further, when the notification indicates activation of an inquiry in step S41, the inquiry is also registered.

In addition, the description of registering the record information in the survey management table Tb1 in step S41 is not limited to one record. When the notification from the form data management server 11 indicates activation of surveys with respect to a plurality of merchandise at the same time, records corresponding to the plurality of merchandise are registered.

When merchandise is registered previously, and the notification from the form data management server 11 indicates updated information about the merchandise, a corresponding record for the merchandise in the survey management table Tb1 is updated.

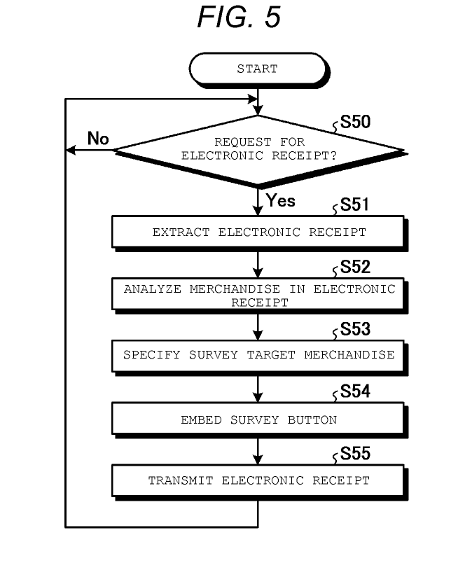

FIG. 5 is a flow diagram of a process to transmit an electronic receipt in which a survey button is embedded to the customer terminal 16.

First, it is determined whether a transmission request for an electronic receipt is received from the customer terminal 16 (S50). When the transmission request is determined to not received (No in S50), the determination is repeated until another transmission request is received.

When the transmission request is determined to be received in the process of step S50 (Yes in S50), the electronic receipt is extracted from the electronic receipt management table (S51). In step S51, the electronic receipt is extracted from the electronic receipt management table using search keys such as a member code, date, and a store name, all of which are included in the transmission request transmitted from the customer terminal 16.

Next, the extracted electronic receipt is analyzed, and information of merchandise is extracted (S52). For example, merchandise code of all merchandise included in the electronic receipt is extracted by using, as a clue, information such as a tag that indicates where the merchandise is written in the electronic receipt.

Next, whether or not the extracted merchandise is a survey target is determined (S53). In step S53, the merchandise code 30 of the survey management table Tb1 is searched by using the merchandise code extracted in step S52, and the matched record is extracted. Then, merchandise corresponding to a record in which numbers (that is, other than “Null”) are set in the survey number 31 is determined to be a survey target.

Next, the survey button is embedded in the electronic receipt (S54). In step S54, the survey button is inserted at a position corresponding to display position of the target merchandise on the electronic receipt (e.g., next to the merchandise name). The survey button is, for example, an icon image that is created in GIF or JPEG format and processing of the survey button is defined by a script and the like. Then, the electronic receipt in which the survey button has been embedded is transmitted to the customer terminal 16 that has transmitted the request (S55).

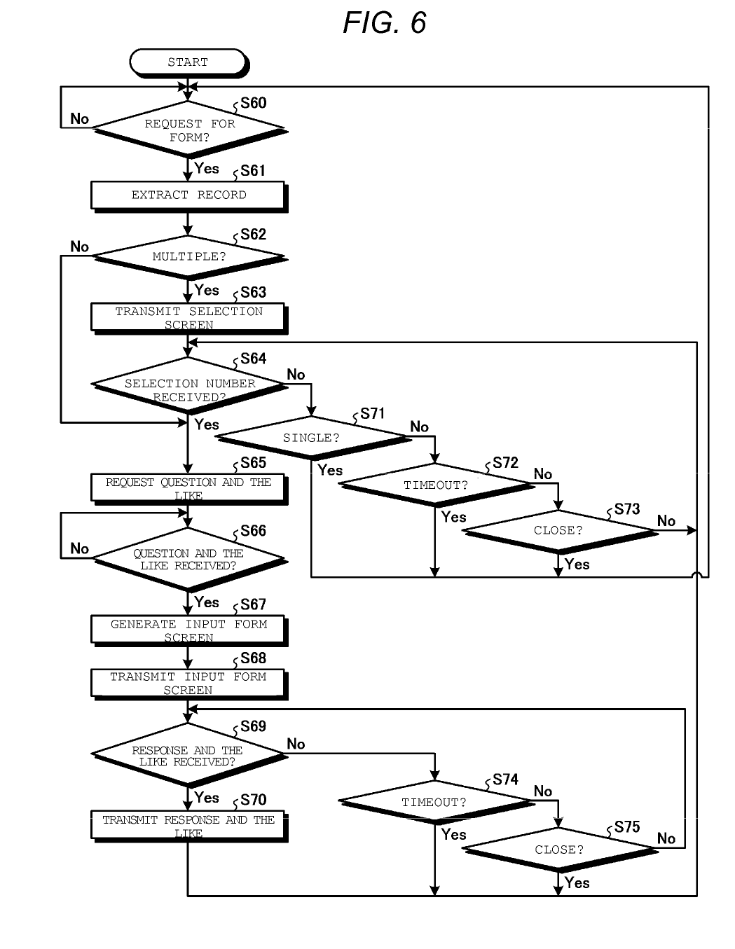

FIG. 6 is a flow diagram of a transmission and reception process of the survey input form. First, it is determined whether a transmission request for the survey input form by the selection signal of the survey button is received from the customer terminal 16 (S60). When the transmission request is determined to be not received (No in S60), the determination is repeated until another transmission request is received.

When the transmission request is determined to be received in step S60 (Yes in S60), the record of corresponding merchandise is extracted from the survey management table Tb1 (S61). In step S61, the record of the merchandise is extracted from the survey management table Tb1 by using, as a search key, the merchandise code included in the request for the survey input form. The merchandise code corresponds to the selected survey button.

Next, it is determined whether or not the selection screen is necessary, based on the values of the survey number and the inquiry number included in the extracted record (S62). In step S62, when a number (other than “Null”) is set only for the survey number “single” is output as a determination result, and when a number is set further for the inquiry number, “multiple” is output as a determination result. In FIG. 3, the merchandise 1 in the record 301 is determined as “single”, and the merchandise 4 in the record 304 is determined as “multiple”.

When the determination result in step S62 is “multiple” (Yes in S62), the selection screen is transmitted to the customer terminal 16 (S63). This selection screen is prepared in advance and includes titles of the fields other than the merchandise code 30 of the survey management table Tb1 as selection buttons. In the present example, two titles of the survey number 31 and the inquiry number 32 of the survey management table Tb1 are included in the selection screen as selection buttons. The selection buttons are associated with an obtaining process of the survey input form and an obtaining process of an inquiry input form, respectively.

Next, it is determined whether the selection signal of the selection button is received from the customer terminal 16 (S64). When the selection signal is determined to be received in (Yes in S64), a request for extraction of data to be displayed on the input form is sent to the form data management server 11 (S65). In step S65, a request for extracting data of the corresponding merchandise for the input form is sent to the form data management server 11, based on processing information of the selection button, which is transmitted as the selection signal of the selection button from the customer terminal 16. For example, when the selection button corresponds to a request for the survey input form, the corresponding merchandise code is transmitted to the form data management server 11, and extraction of data to be displayed on the survey input form is requested. When the selection button corresponds to a request for the inquiry input form, the corresponding merchandise code is transmitted to the form data management server 11, and extraction of data to be displayed on the inquiry input form is requested.

When the determination process of step S62 is “single” (No in S62), the process proceeds to step S65, and the above process is performed. That is, since there is only a request for the survey input form, the corresponding merchandise code is transmitted to the form data management server 11, and extraction of data to be displayed on the survey input form is requested.

After step S65, it is determined whether data to be displayed on the input form is received from the form data management server 11 (S66). When the data is determined to be not received (No in S66), the determination is repeated until further data is received. When the data is determined to be received (Yes in S66), an input form screen is generated (S67). In step S67, a conversion process is performed with respect to the data received from the form data management server 11 so that the data can be displayed at a predetermined position of the input form screen on the customer terminal 16. For example, a survey input form template including a plurality of input boxes is prepared in advance, and question insertion positions for each input box are managed with index numbers (a question 1, a question 2, a question 3, The question 1, the question 2, the question 3, . . . are received from the form data management server 11 as multiple questions, and each question is inserted at a question insertion position that has the same index number as the question. The input form into which the question is inserted is appropriately converted according to the environment of the customer terminal 16 in order that the input form can be displayed on the customer terminal 16.

The input form is transmitted to the customer terminal 16 that is has transmitted the request after step S67 (S68). Next, it is determined whether the input data in the input form is received from the customer terminal 16 (S69). When the input data is determined to be received (Yes in S69), the received data is transmitted to the form data management server 11 (S70). For example, since the input data is a response to the survey when the data is input in the survey input form, the response is transmitted to the form data management server 11 with the subsidiary information (merchandise code, electronic receipt number, and the like). Similarly, since the input data is an inquiry when the data is input in the inquiry input form, the inquiry is transmitted to the form data management server 11 with the subsidiary information.

After step S70, a count for a timeout determination (S72) is initialized, and the processes from step S64 are repeated in the same manner.

When the selection signal of the selection button is determined to be not received (No in S64), the process proceeds to step S71. In step S71, whether or not selection on the selection screen is single is determined. This determination process is opposite to the determination in step S62. Step S72 is a determination process of whether a timeout occurs (determined to be Yes when a timeout occurs). A timer is set to ON in step S63 until a timeout occurs, and a timeout occurs after a predetermined time. Step S73 is a determination process of whether a selection signal of a close button is received (determined to be Yes when the selection signal is received). Step S73 is intended to detect whether the selection screen displayed on the customer terminal 16 is closed. When all of the determinations in steps S71 to S73 are No, the process returns to step S64. When any of the determinations in steps S71 to S73 is Yes, the process returns to step S60.

When the response information and the like are determined to be not received (No in S69), the process proceeds to step S74. Step S74 is a determination process of whether a timeout occurs (determined to be Yes when a timeout occurs). A timer is set to ON in step S68 until a timeout occurs, and a timeout occurs after a predetermined time. Step S75 is a determination process of whether the selection signal of the close button is received (determined to be Yes when the selection signal of the close button is received). Step S75 is intended to detect whether the input form screen displayed on the customer terminal 16 is closed. When all of the determinations in steps S74 and S75 are No, the process returns to step S69. When any of the determinations in steps S74 and S75 is Yes, the process returns to the step S64.

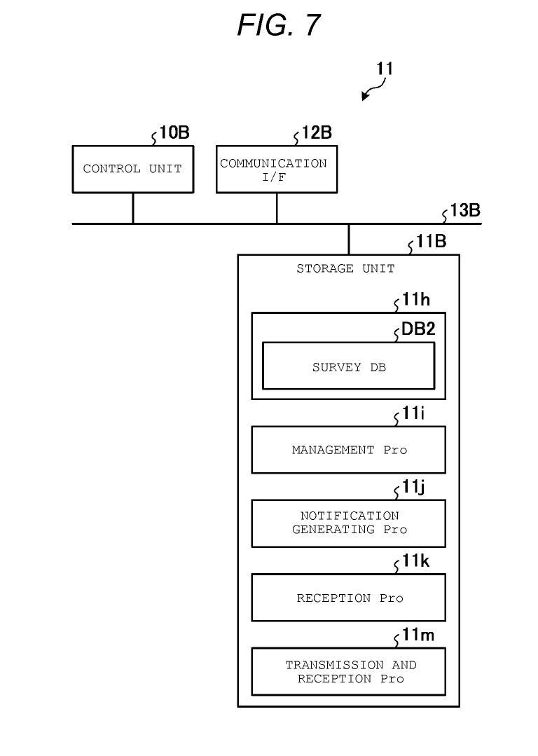

Next, the configuration of the form data management server 11 will be described. FIG. 7 is a block diagram of the form data management server 11. The form data management server 11 includes a control unit 10B, a storage unit 11B, and a communication I/F 12B. The control unit 10B, the storage unit 11B, and he communication I/F 12B are connected to each other through a bus 13B.

The control unit 10B is a computer that collectively controls each unit of the form data management server 11 and performs operation processing, data input and output control, and the like. The control unit 10B includes a CPU, a ROM. that stores various programs and data, a RAM as a working memory for loading various programs and storing data in a rewritable manner, an RTC unit that indicates the current date and time, and the like.

The storage unit 11B is an auxiliary storage device such as an HDD and an SSD. Various programs illustrated below are loaded into the RAM of the control unit 10B and are executed by the CPU to function as a survey managing section (not illustrated), the provided information registering section 110, the extracting section 111, the response information registering section 112, and the like, which are illustrated in FIG. 1.

The storage unit 11B includes a storage region 11h of a database to manage the survey, that is, the database DB2 (FIG. 1). In addition, the storage unit 11B stores a survey management program 11i.

The database DB2 includes various tables to manage the survey-related questions from the consumer goods maker, the response by the customer to the questions, classifications of inquiry from the consumer goods maker, inquiries from the customer, and the like.

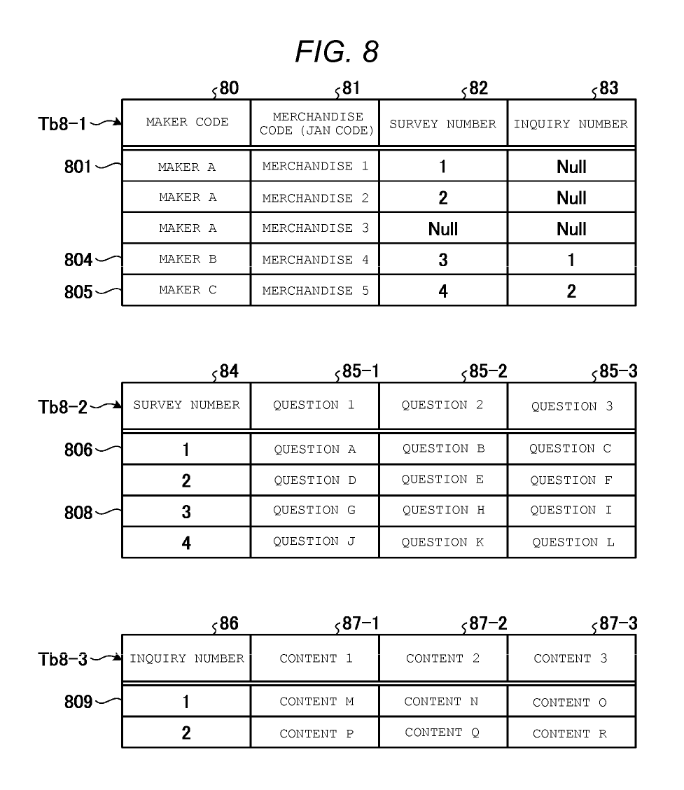

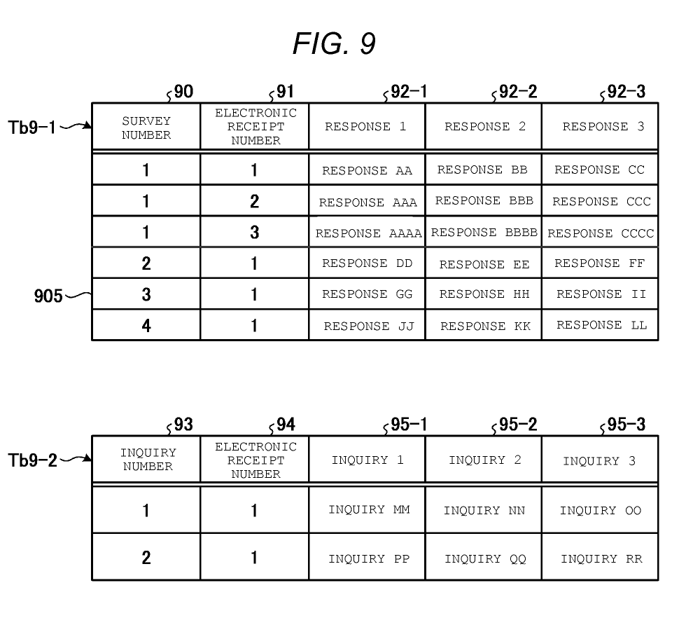

FIG. 8 and FIG. 9 are examples of a table to manage the survey and the like.

FIG. 8 is a table (survey management table) to manage the questions and the classifications of inquiries, both of which are provided from the consumer goods maker.

FIG. 9 is a table (survey result management table) to manage responses to the questions and the inquiries , both of which are received from customers.

In FIG. 8, the survey management table includes three tables of a survey registration table Tb8-1, a question registration table Tb8-2, and an inquiry classification registration table Tb8-3.

The survey registration table Tb8-1 includes “maker code” 80, “merchandise code” 81, “survey number” 82, and “inquiry number” 83 as main fields.

“Maker code” 80 is a field to store an identification code of a consumer goods maker. In FIG. 8, the identification code of the consumer goods maker is illustrated as a maker A, a maker B, a maker C, and the like.

“Merchandise code” 81 is a field to store a standardized code, which is a combination of numbers and alphabet characters and includes a code assigned to each consumer goods maker, that is, the JAN code in the present embodiment. In FIG. 8, the JAN code is illustrated as merchandise 1, merchandise 2, and the like.

“Survey number” 82 is a field to store a serial number of a survey in the present embodiment. In the present example, the serial number is illustrated as stores 1, 2, 3, and the like, and “Null” is used when a survey number is not assigned.

“Inquiry number” 83 is a field to store a serial number of an inquiry in the present embodiment. In the present example, the serial number is illustrated as 1, 2, 3, and the like, and “Null” is used when an inquiry number is not assigned.

The information stored in each field on a same row is correlated, as a single record unit. Five records in FIG. 8 are illustrated as an example. The question registration table Tb8-2 includes “survey number” 84, “question 1” 85-1, “question 2” 85-2, and “question 3” 85-3 as main fields.

“Survey number” 84 is a field correlated with “survey number” 82 of the survey registration table Tb8-1. “Survey number” 84 is a field to store the serial number of a survey.

“Question 1” 85-1, “question 2” 85-2, and “question 3” 85-3 each are a field to store a question. In the present example, the number of question fields is limited to three, so that the number of questions is limited up to three. However, the number of question fields may be appropriately increased or decreased, and the number of questions may be changed. In FIG. 8, each question is illustrated as a question A to a question L. Each question is the content of an individual survey such as “How is the operability of merchandise?” on each merchandise.

The inquiry classification registration table Tb8-3 includes “inquiry number” 86, “content 1” 87-1, “content 2” 87-2, and “content 3” 87-3 as main fields.

“Inquiry number” 86 is a field correlated with “inquiry number” 83 of the survey registration table Tb8-1. “Inquiry number” 86 is a field to store the serial number of an inquiry.

“Question 1” 87-1, “question 2” 87-2, and “question 3” 87-3 are each a field to store a classification of an inquiry. In the present example, the number of inquiry fields is limited to three, so that the number of inquiries is limited up to three. However, the number of inquiry fields may be appropriately increased or decreased, and the number of inquiries may be changed. In FIG. 8, classifications of inquiries are illustrated as a content M to a content R. Examples of each contents are “inquiries about how to operate merchandise” and “inquiries about merchandise return”.

Next, the configuration of the survey result management table will be described.

FIG. 9 is examples of a response registration table Tb9-1 and an inquiry registration table Tb9-2.

The survey result management table includes three tables of the survey registration table Tb8-1 in FIG. 8, and a response registration table Tb9-1 and an inquiry registration table Tb9-2 in FIG. 9.

The response registration table Tb9-1 includes “survey number” 90, “electronic receipt number” 91, “response 1” 92-1, “response 2” 92-2, and “response 3” 92-3 as main fields.

“Survey number” 90 is a field correlated with “survey number” 82 of the survey registration table Tb8-1. “Survey number” 90 is a field to store the serial number of a survey.

“Electronic receipt number” 91 is a unique code assigned to each electronic receipt.

“Response 1” 92-1, “response 2” 92-2, and “response 3” 92-3 are fields to store the response of the customer. Since the number of questions is limited to three in the present example, the number of responses is correspondingly three. When the number of questions is increased or decreased, the number of responses is also increased or decreased accordingly. In FIG. 9, each response is illustrated as a response AA to a response LL, a response AAA to a response CCC, and a response AAAA to a response CCCC. Examples of the responses are “good operability” and “moderate operability”

The inquiry registration table Tb9-2 includes “inquiry number” 93, “electronic receipt number” 94, “inquiry 1” 95-1, “inquiry 2” 95-2, and “inquiry 3” 95-3 as main fields.

“Inquiry number” 93 is a field correlated with “inquiry number” 83 of the survey registration table Tb8-1. “Inquiry number” 93 is a field to store a serial number of an inquiry.

“Electronic receipt number” 94 is a unique code assigned to an electronic receipt.

“Inquiry 1” 95-1, “inquiry 2” 95-2, and “inquiry 3” 95-3 are field to store the specific content of inquiry from the customer. Since the number of classifications of inquiry is limited to three in the present example, the number of inquiries is three. When the number of classifications of inquiry is increased or decreased, the number of inquiries is also increased or decreased accordingly. In FIG. 9, specific content of inquiries is illustrated as an inquiry MM to an inquiry RR. Examples of the specific content of inquiry are “I don't understand how to turn on the power button” and “Can I return merchandise by mail?”

Description returns to the configuration of the form data management server 11 in FIG. 7.

The survey management program 11i is executed to, for example, extract, register, update, and delete information in various tables in the database DB2 and manage information.

A notification generating program 11j is a program executed to notify the electronic receipt management server 10 of activation of a survey. The notification is performed by transmitting the information that indicates activation of a survey of merchandise registered in the survey management table (including activation of an inquiry if any) to the electronic receipt management server 10. The notification may be performed regularly at each time of registration of the question and the like in the survey management table or at a predetermined timing. The merchandise of which the electronic receipt management server 10 is notified of the activation of a survey may be limited to merchandise that is updated after a previous notification or all merchandise in the survey management table.

A reception program 11k is a program executed to, for example, receive a registration request for a question(or inquiry), an extraction request for the response (or the content of an inquiry) from the input terminal 120, and an extraction request for the question (or inquiry) from the electronic receipt management server 10.

The reception program 11k is accessed by the input terminal 120. When a registration request for the question (or inquiry) is received, the reception program 11k is executed to transmit a registration form for the question (or inquiry) to the input terminal 120. Thereafter, when data input in the registration form is received from the input terminal 120, the survey management program 11i is executed to register the received data in the survey management table.

When an extraction request for the response (or inquiry) is sent from the input terminal 120, the survey management program 11i is executed to extract the response (or the inquiry) about merchandise designated by the input terminal 120 from the survey result management table. Then, the reception program 11k is executed to transmit the extraction result to the input terminal 120. Here, the response (or inquiry) to all merchandise may be transmitted to the consumer goods maker server 12. In this case, the response (inquiry) to all merchandise produced by the consumer goods maker is extracted from the survey result management table by referring to a table of correspondence between each consumer goods maker and the merchandise code.

When an extraction request for the question (or inquiry) is received from the electronic receipt management server 10, the survey management program 11i is executed to extract the question (or inquiry) about merchandise designated by the electronic receipt management server 10 from the survey management table. Then, the extraction result is transmitted to the electronic receipt management server 10.

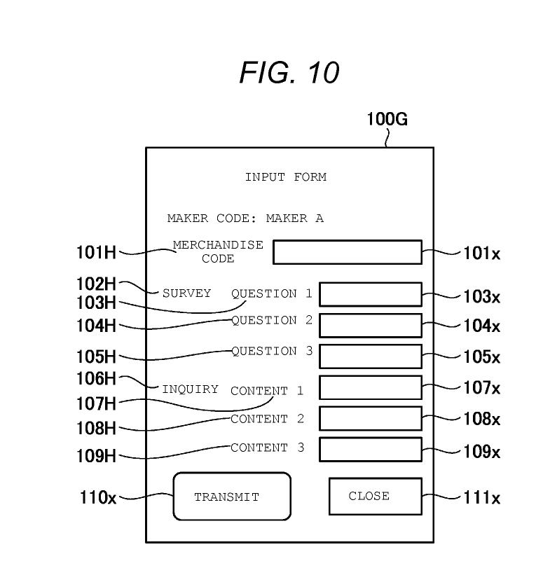

FIG. 10 is an example of the registration form screen displayed on the input terminal 120.

In a registration screen 1000 in FIG. 10, a merchandise code input box 101x is disposed next to a merchandise code display 101H. Displays 103H to 105H for the question 1 to the question 3 are disposed next to a survey display 102H, and question input boxes 103x to 105x are respectively disposed next to the displays 103H to 105H. In addition, displays 107H to 109H for the content 1 to the content 3 are provided next to an inquiry display 106H, and content input boxes 107x to 109x are respectively disposed next to the displays 107H to 109H. A transmit button 110x and a close button 111x are disposed in the lower portion of the screen.

A staff of the consumer goods maker registers the question and the classification of inquiry to the form data management server 11 by appropriately filling in the input boxes and selecting the transmit button 110x.

Description returns to the configuration of the form data management server 11 in FIG. 7.

A transmission and reception program 11m is a program executed to transmit and receive data through the communication I/F 12B. The transmission and reception of data is carried out mainly with the electronic receipt management server 10 and the consumer goods maker server 12 (input terminal 120). When there is access to the transmission and reception program 11m from the electronic receipt management server 10 or the input terminal 120, and a request for a survey (or inquiry) is included in access data, the reception program 11k is executed to process the request and transmit the processing result to the requester.

The communication I/F 12B is a communication interface that is connected to the network N3 and the electronic receipt management server 10 that is in the same network.

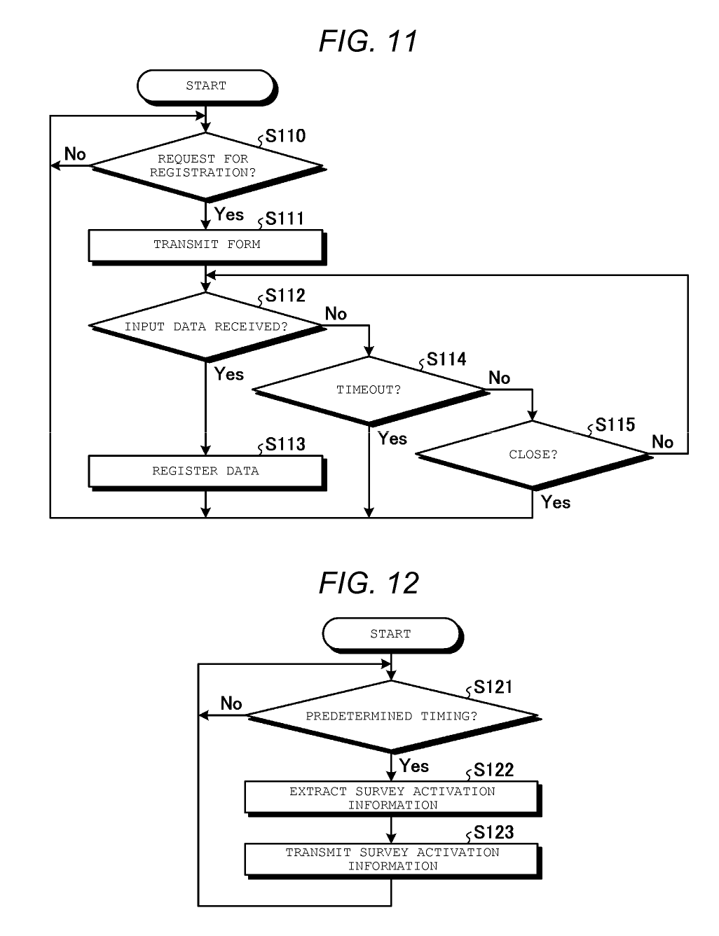

FIG. 11 to FIG. 14 are flow diagrams of the survey collecting process performed by the form data management server 11. Each process described below is performed by the CPU of the control unit 10B executing various programs stored in the storage unit 11B or supplementary programs. The initializing process and the ending process are omitted in FIG. 11 to FIG. 14. The ending process is desirably performed after the end of a series of process. When ending a process at an appropriate timing, the ending process is assumed to notify processes that are related to each other and also end the related processes.

FIG. 11 is a flow diagram of a registration process of a question.

First, it is determined whether or not a registration request for a question is received from the input terminal 120 (S110). When the registration request is determined to be not received (No in S110), step S110 is repeated until the registration request is determined to be received.

When the registration request is determined to be received (Yes in S110), the registration form (refer to FIG. 10) is transmitted to the input terminal 120 (S111).

Next, it is determined whether or not data input in the registration form screen is received (S112). When a staff of the consumer goods maker inputs data such as the merchandise code and the question in the registration form screen on the input terminal 120 and selects the transmit button, the input data is transmitted from the input terminal 120 to the form data management server 11, and the input data is determined to be received in step S112.

When the input data is received, the data registration process is next performed (S113), and thereafter the process returns to step S110.

When the input data is determined to be not received (No in step S112), a determination process of a timeout (S114) and/or a determination process of the close button (S115) is performed.

In step S114, it is determined whether or not a predetermined time does not pass since time tracking by a timer started. For example, time tracking is started after transmission of the registration form to the input terminal 120 (S111), and it is determined whether a predetermined time does not pass.

In step S115, it is determined whether or not a signal that indicates selection of the close button on the registration form screen on the input terminal 120 is received.

When all determinations in step S114 and step S115 are No, the process returns to step S112. When any of the determinations in step S114 and step S115 is Yes, the process returns to step S110.

Next, the data registration process in step S113 will be described.

The data registration process is a process to register activation of a survey of merchandise in the survey management table by using the merchandise code of the input data received from the input terminal 120 as a search key. The data registration process is specifically described as follows with reference to the tables in FIG. 8, as an example.

First, the merchandise code input on the input terminal 120 is searched for in “merchandise code” 81 of the survey registration table Tb8-1. When the search key is, for example, merchandise 6, the merchandise 6 is not hit because the merchandise 6 is not registered in the survey registration table Tb8-1 as illustrated in FIG. 8. In this case, a new record is generated in the survey registration table Tb8-1.

The contents of the record are as follows when only the question information data is input on the input terminal 120 of a maker C and the classification of an inquiry is not input.

“Maker code” 80, “merchandise code” 81, “survey number” 82, and “inquiry number” 83 of the record are respectively “maker C”, “merchandise 6”, “5”, and “Null”. Since four surveys are previously issued in FIG. 8, the number “5” of “survey number” 82 is assigned as a serial number continuing from “4”.

When the data input on the input terminal 120 of the maker C is a question and a classification of an inquiry, the contents of the record are as follows.

“Maker code” 80, “merchandise code” 81, “survey number” 82, and “inquiry number” 83 of the record are respectively “maker C”, “merchandise 6”, “5”, and “3”. Since two inquiries are issued in FIG. 8, the number “3” of “inquiry number” 83 is assigned as a serial number continuing from “2”.

In a case of “empty input” where only the merchandise code is input, and neither a question nor a classification of an inquiry is input on the input terminal 120 of the maker C, all of “survey number” 82 and “inquiry number” 83 are set as “Null”.

Next, the question is registered in the question registration table Tb8-2, and the inquiry is registered in the inquiry classification registration table Tb8-3. Data is registered in the inquiry classification registration table Tb8-3 only when the classification of inquiry is input on the input terminal 120 of the maker C.

First, the survey number “5” is searched for in “survey number” 84 of the question registration table Tb8-2. Since the survey number “5” is newly generated, the corresponding question is not registered and thus is not extracted. Therefore, a record having the survey number “5” is newly generated. As the contents of the record, “survey number” 84, “question 1” 85-1, “question 2” 85-2, and “question 3” 85-3 are respectively “5”, “question M”, “question N”, and “question 0”.

Next, the inquiry number “3” is searched for in “inquiry number” 86 of the inquiry classification registration table Tb8-3 when the classification of inquiry is input on the input terminal 120 of the maker C. Since the inquiry number “3” is newly generated, the corresponding information is not registered and thus is not extracted. Therefore, a record having the inquiry number “3” is newly generated. As the contents of the record, “inquiry number” 86, “content 1” 87-1, “content 2” 87-2, and “content 3” 87-3 are respectively “3”, “content S”, “content T”, and “content U”.

The flow of processes is described so far as in the case of registering a new merchandise code and the like, but when the merchandise code has been already registered, the extracted records for each registration are updated by using the newly input data.

FIG. 12 is a flow diagram of a process to notify activation of a survey to the electronic receipt management server 10.

First, it is determined whether a predetermined timing comes (S121). An example of a predetermined timing is a timing when the survey registration table Tb8-1 is updated in response to a registration request from the input terminal 120. Another example is a predetermined time such as 10 o'clock and 12 o'clock or every predetermined period such as every one hour, every one day, and every one week. Another example is a timing when a predetermined operation such as launching is performed.

When it is determined that a predetermined timing does not come (No in S121), the determination process is repeated until the predetermined timing arrives.

When it is determined that a predetermined timing comes (Yes in S121), the information that indicates activation of a survey is extracted (S122). For example, record information that is registered in the survey registration table Tb8-1 in FIG. 8 and includes data of the merchandise code 81, the survey number 82, and the inquiry number 83 is extracted as the information that indicates activation of a survey. When only the record of the merchandise 5 of the maker C is registered after the previous notification, the merchandise code “merchandise 5”, the survey number “4”, and the inquiry number “2” of a record 805 of the merchandise 5 are extracted.

After step S122, notification of the activation of a survey of the corresponding merchandise is made by transmitting the extracted information to the electronic receipt management server 10 (S123).

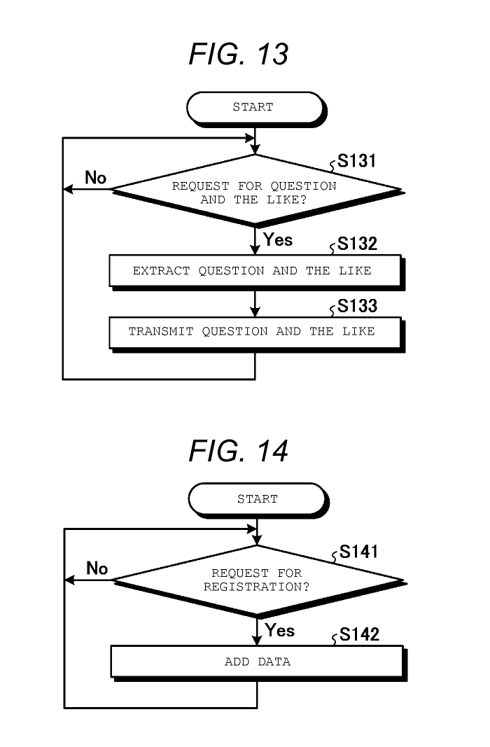

FIG. 13 is a flow diagram of a process to search a question and the like when an extraction request for the question and the like is received from an electronic receipt management server 10.

First, it is determined whether or not an extraction request for a question and the like is received (S131). When the extraction request is determined to be not received (No in S131), the determination process is repeated until the extraction request is received.

When the extraction request is determined to be received (Yes in S131), the question and the like are extracted (S132). In S132, the question and the like are extracted from the survey management table by using the survey number and the inquiry number (or merchandise code), both of which are included in the request signal from the electronic receipt management server 10 as search keys. This process is described as follows with reference to FIG. 8.

It is assumed that the merchandise code “merchandise 1” is transmitted from the electronic receipt management server 10. In this case, “merchandise code” 81 of the survey registration table Tb8-1 is searched by using “merchandise 1” as a search key. In FIG. 8, a record 801 is hit as the search result. The record 801 includes the survey number “1”. Therefore, “survey number” 84 of the question registration table Tb8-2 is searched next by using the survey number “1” as a search key. A record 806 is het as the search result and is extracted.

When the survey number “1” is transmitted from the electronic receipt management server 10, “survey number” 84 of the question registration table Tb8-2 is searched by directly using the survey number “1 as a search key. The record 806 is hit as the search result and is extracted.

The extracted data is transmitted to the electronic receipt management server 10 in step S133 as a combination of the survey number “1”, the question 1 “question A”, the question 2 “question B”, and the question 3 “question C”.

Although the inquiry number is not issued in the operations described above, operations are performed in the same manner for merchandise for which the inquiry number is issued.

It is assumed that the merchandise code “merchandise 4” is transmitted from the electronic receipt management server 10. In this case, “merchandise code” 81 of the survey registration table Tb8-1 is searched by using “merchandise 4” as a search key. In FIG. 8, a record 804 is hit as the search result. The record 804 includes the survey number “3” and the inquiry number “1”. Therefore, “survey number” 84 of the question registration table Tb8-2 is searched next by using the survey number “3” as a search key. A record 808 is hit as the search result and is extracted. In addition, “inquiry number” 86 of the inquiry classification registration table Tb8-3 is searched by using the inquiry number “1” as a search key. A record 809 is hit as the search result and is extracted.

When the inquiry number “1” is transmitted from the electronic receipt management server 10 instead of the merchandise code, “inquiry number” 86 of the inquiry classification registration table Tb8-3 is searched by directly using the inquiry number “1” as a search key. The record 809 is hit as the search result and is extracted.

The extracted data is transmitted to the electronic receipt management server 10 in step S133 as a combination of the inquiry number “1”, the content 1 “content M”, the content 2 “content N”, and the content 3 “content O”.

After the extraction process of step S132, the extracted data and the like are transmitted to the electronic receipt management server 10 (S133).

FIG. 14 is a flow diagram illustrating a registration process when a registration request for a response and the like is received from the electronic receipt management server 10.

First, it is determined whether or not an extraction request for a response and the like is received from the electronic receipt management server 10 (S141). When the extraction request is determined to be not received (No in S141), the determination process is repeated until the extraction request is received.

When the extraction request is determined to be received (Yes in S141), the response and the like are added to the survey result management table (S142). This process is described as follows with reference to FIG. 9.

Here, it is assumed that the survey number “1”, the electronic receipt number “4”, and the response information are transmitted from the electronic receipt management server 10. This combination means that the customer responds to the survey number “1” on the survey input form that is requested during display of the electronic receipt number “4”.

In this case, when the survey number “1” and the electronic receipt number “4” are combined and used as a search key, a corresponding record for the response to the survey number “1” does not exist because the electronic receipt number “3” is the last registered one as illustrated in FIG. 9. Therefore, a record is newly added. Specifically, “survey number” 90 and “electronic receipt number” 91 respectively store “1” and “4”, and “response 1” 92-1, “response 2” 92-2, and “response 3” 92-3 respectively store three received responses.

Here, it is assumed that the inquiry number “1”, the electronic receipt number “4”, and the classification of inquiry are transmitted from the electronic receipt management server 10. This combination means that the customer responds to the inquiry number “1” on the inquiry input form that is requested during display of the electronic receipt number “4”.

In this case, when the inquiry number “1” and the electronic receipt number “4” are combined and used as a search key, a corresponding record for the response to the inquiry number “1” does not exist because the electronic receipt number “1” is the last registered one as illustrated in FIG. 9. Therefore, a record is newly added. Specifically, “inquiry number” 93 and “electronic receipt number” 94 respectively store “1” and “4”, and “inquiry 1” 95-1, “inquiry 2” 95-2, and “inquiry 3” 95-3 respectively store three inquiries.

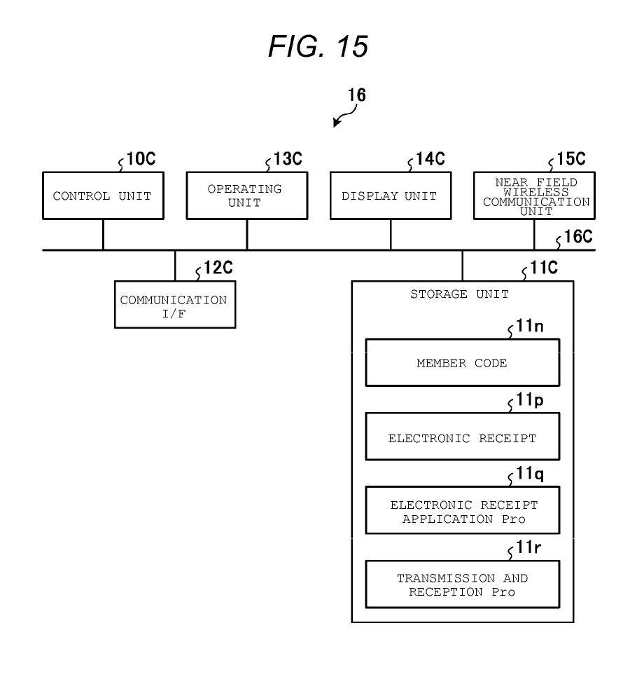

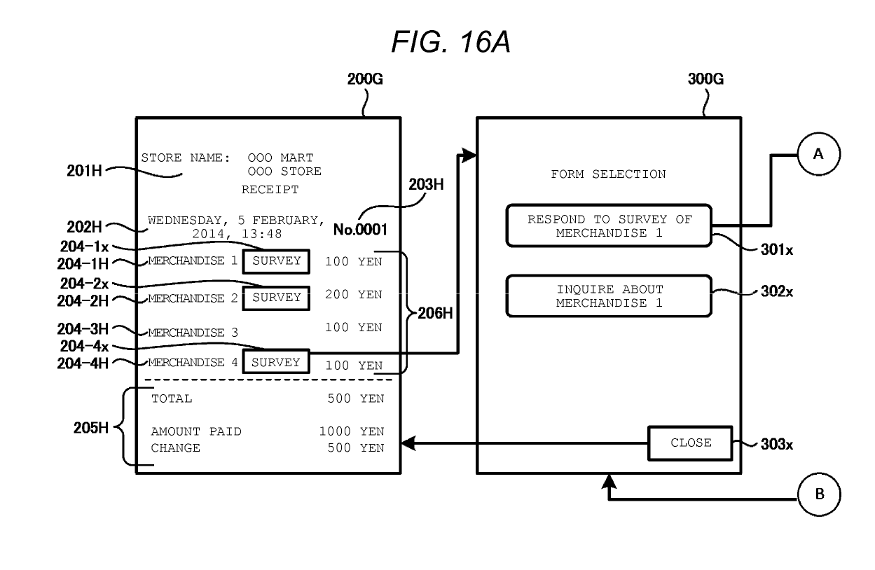

FIG. 15 is a configuration diagram of the customer terminal 16.The customer terminal 16 has a control unit 10C, a storage unit 11C, a communication I/F 12C, an operating unit 13C, a display unit 14C, and a near field wireless communication unit 15C, which are connected to each other through a bus 16C.

The control unit 10C is a computer that collectively controls various operations and each unit of the customer terminal 16 and performs operation processing, data input and output control, and the like. The control unit 10C includes a CPU, a ROM that stores various programs and data, a RAM as a working memory for loading various programs and storing data in a rewritable manner, an RTC unit that indicates the current date and time, and the like.

The operating unit 13C is an input device that transmits an input signal from, for example, a touch input display screen to the control unit 10C. The operating unit 13C transmits a predetermined command code and data input thereto through an interface such as an input button and an input box on a liquid crystal display, to the control unit 10C.

The display unit 14C is a display device that displays display data generated by the control unit 10C. A display target is, for example, a touch input display screen.

The near field wireless communication unit 15C is a communication interface that wirelessly communicates with a near field wireless communication unit of the POS terminal 15 and transmits and receives data.

The communication I/F 12C is a communication interface that is connected to the network N4 and accesses the Internet through a mobile telephone network and the like.

The storage unit 11C is a storage device such as an internal memory and a detachable external storage device (for example, a flash memory). The storage unit 11C includes a member code storage region 11n and an electronic receipt management region 11p, and stores an electronic receipt application 11q, a transmission and reception program 11r, and the like.

The electronic receipt management region 11p is a region to store downloaded electronic receipts and the like.

The electronic receipt application 11q is a program to manage electronic receipts stored in the electronic receipt management region 11p. In addition, the electronic receipt application 11q is a program to selectively downloads electronic receipts from the electronic receipt management server 10. By the execution of the electronic receipt application 11q, target electronic receipts are extracted based on, for example, a transaction date and a store name. In addition, the electronic receipt application 11q is a program (Web browser and the like) to display various input forms and electronic receipts that are received from the electronic receipt management server 10 on a display screen and transmit a request that is specified by the operating unit to the electronic receipt management server 10.

The transmission and reception program 11r is a program to communicate data with the electronic receipt management server 10 in a predetermined protocol (HTTP and the like).

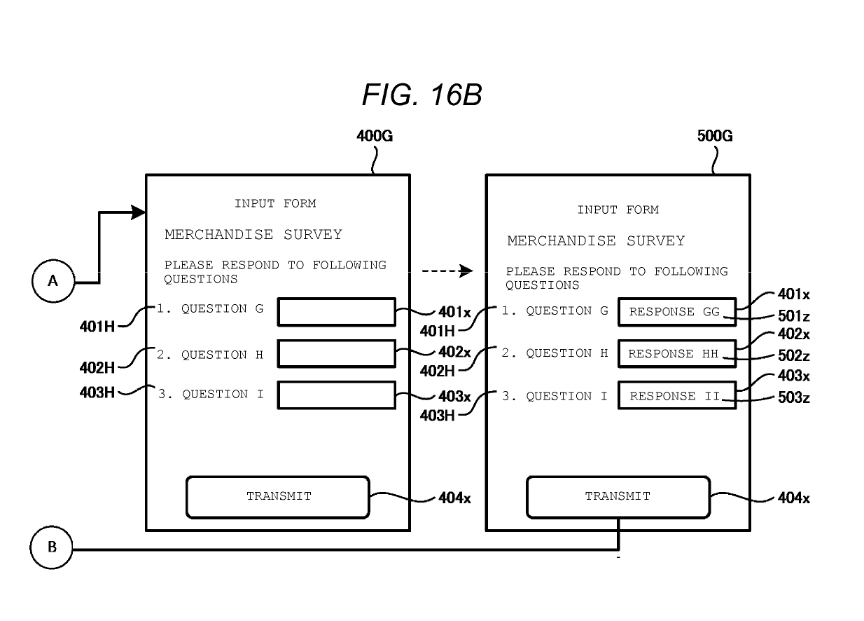

FIGS. 16A and 16B illustrate screen transition of screens for describing the flow of the survey collecting process performed by the customer terminal 16. Solid arrows in FIGS. 16A and 16B illustrate destinations of screen transitions.

An electronic receipt screen 200G in FIG. 16A includes display elements such as a store name 201H, a transaction date and time 202H, an electronic receipt number 203H, merchandise codes 204-1H to 204-4H of purchased merchandise (four items in the present example), price 206H of each merchandise, and a settled amount 205H such as a total price and change. Particularly, since the electronic receipt number 203H is illustrated as “No: 0001”, the corresponding electronic receipt has the electronic receipt number “1”. As such, the electronic receipt number is transmitted from the electronic receipt management server 10 in a displayable form as being incorporated into the electronic receipt.

Operable survey buttons are disposed next to each merchandise code in the electronic receipt screen 200G. In the example in FIG. 16A, survey buttons 204-1x, 204-2x, and 204-4x are disposed respectively adjacent to the merchandise 1, the merchandise 2, and the merchandise 4. That is to say, survey input forms for the merchandise 1, the merchandise 2, and the merchandise 4 are provided to the customer, who is the operator, by displaying survey buttons adjacent to each merchandise other than the merchandise 3.

The electronic receipt screen 200G transitions to a form selection screen 300G when the operator selects any of the survey buttons 204-1x to 204-4x on the screen of the electronic receipt screen 200G, and the survey and the inquiry, both of which correspond to the selected survey button, are registered. Data of the form selection screen 300G is transmitted from the electronic receipt management server 10 by the selection of the survey button. When only the survey that corresponds to the selected survey button is registered and the inquiry is not registered, display of the form selection screen 300G is omitted, and the electronic receipt screen 200G transitions to an input form screen 400G. In FIG. 16A, the survey button of the merchandise 4 is selected, and the screen transitions. The survey number “3” and the inquiry number “1” are set in the record 304 that corresponds to the merchandise code “merchandise 4” in the survey management table Tb1 in FIG. 3. Thus, in the screen transition example illustrated in FIG. 16A, the electronic receipt screen 200G transitions to the form selection screen 300G after selection of the survey button.

The form selection screen 300G mainly includes a button 301x that requests the survey input form, a button 302x that requests the inquiry input form, and a close button 303x.

The close button 303x is used to return to the electronic receipt screen 200G.

The input form screen 400G is a screen to input response to a survey and transitioned from the form selection screen 300G when the button 301x that requests the survey input form is selected in the form selection screen 300G. Although not particularly illustrated, the form selection screen 300G transitions to an inquiry input form screen when the button 302x that requests the inquiry input form is selected in the form selection screen 300G. Data of these input form screens are transmitted from the electronic receipt management server 10.

The survey input form screen 400G illustrated in FIG. 16B includes a question G, a question H, and a question I as display information 401H to display information 403H. The question G, the question H, and the question I are displayed by inserting the information of the record 808 that has the survey number “3” and is registered in the question registration table Tb8-2 in FIG. 8, that is, “question G” in the question 1, “question H” in the question 2, and “question I” in the question 3.

Input boxes 401x to 403x are disposed adjacent to each of the display information 401H to the display information 403H to which the question is attached.

A transmit button 404x is disposed in the lower portion of the survey input form screen 400G.

An input screen 500G is illustrated adjacent to the right of the survey input form screen 400G in FIG. 16B as an input example of the input boxes 401x to 403x.

As illustrated in FIG. 16B, the input boxes 401x to 403x illustrate a state where “response GG”, “response HH”, and “response II” are respectively input as input data 501z to input data 503z. The pieces of input data “response GG”, “response HH”, and “response II” are transmitted to the form data management server 11 via the electronic receipt management server 10 by selection of the transmit button 404x. After the transmit button 404x is selected, the input screen 500G returns to the form selection screen 300G in this example. In a case of merchandise for which the form selection screen 300G is not displayed, the input screen 500G returns to the electronic receipt screen 200G.

The input data “response GG”, “response HH”, and “response II” that are transmitted to the form data management server 11 are registered in a record 905 having the survey number “3” and the electronic receipt number “1” in the response registration table Tb9-1 as the response 1 “response GG”, the response 2 “response HH”, and the response 3 “response II” through the registration process illustrated in FIG. 14.

In the present embodiment, the response is transmitted to the form data management server 11 with the subsidiary information (the merchandise code, the electronic receipt number, and the like). The subsidiary information is described as including the electronic receipt number, but besides may include information such as sex and an age group and may be transmitted to the form data management server 11. In this case, a maker can determine the total number of surveys by using factors such as sex and an age group.

Various programs used in the server apparatus according to the present embodiment may be provided as files in installable format or executable format being recorded on a non-transitory computer-readable recording medium such as a CD-ROM, a flexible disk (FD), a CD-R, and a digital versatile disk (DVD) and may be executed after being read into a flash ROM and the like of the server apparatus.

The programs may be provided as being stored on a computer that is connected to a network such as the Internet and being downloaded via the network.

According to an embodiment, a system for collecting information about a plurality of products includes a first server and a second server. The first server stores a plurality of surveys and correlates each of the surveys to a product ID and one or more completed surveys, and is configured to respond to a survey request with a survey corresponding to a product ID included in the survey request. The second server is networked to a plurality of store servers and a plurality of mobile computing devices of users. The second server is configured to receive and store electronic receipt data generated by the store servers in connection with purchase transactions of products, and to transmit electronic receipt data of a first type that includes a link to a survey stored in the first server and electronic receipt data of a second type that does not include the link. The first server receives completed surveys transmitted from each of the mobile computing devices that received the electronic receipt data of the first type, accessed one of the surveys stored in the first server through the link, and then indicated completion of the survey.

According to an embodiment, a system for collecting information about a plurality of products includes a first server and a second server. The first server stores one or more questions about the products, each question being correlated to a product ID, and is configured to response to a question request with a question form corresponding to a product ID included in the question request. The second server is networked to a plurality of store servers and a plurality of mobile computing devices of users. The second server is configured to receive and store electronic receipt data generated by the store servers in connection with purchase transactions of products, and to transmit electronic receipt data of a first type that includes a link to a question form stored in the first server and electronic receipt data of a second type that does not include the link. The first server completed questions transmitted from each of the mobile computing devices that received the electronic receipt data of the first type, accessed one of the question forms stored in the first server through the link, and then indicated completion of the question.

Accordingly, it is possible to provide various surveys of makers to consumers in the same procedure and collect survey results from the customers using the electronic receipt system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for collecting information about a plurality of products, comprising:
a first server that stores a plurality of surveys and correlates each of the surveys to a product ID and one or more completed surveys, and is configured to respond to a survey request with a survey corresponding to a product ID included in the survey request; and
a second server networked to a plurality of store servers and a plurality of mobile computing devices of users, the second server being configured to receive and store electronic receipt data generated by the store servers in connection with purchase transactions of products, and to transmit electronic receipt data of a first type that includes a link to a survey stored in the first server and electronic receipt data of a second type that does not include the link,
wherein the first server receives completed surveys transmitted from each of the mobile computing devices that received the electronic receipt data of the first type, accessed one of the surveys stored in the first server through the link, and then indicated completion of the survey.

2. The system according to claim 1, wherein
the second server stores a table including product IDs targeted by the surveys,
the electronic receipt data of the first type is transmitted to the mobile computing devices when a product ID in the electronic receipt data is included in the table, and
the electronic receipt data of the second type is transmitted to the mobile computing devices when no product ID in the electronic receipt data is included in the table.

3. The system according to claim 2, wherein
the second server receives the product IDs targeted by the surveys from the first server.

4. The system according to claim 1, wherein
the second server transmits electronic receipt data of the first type that includes a first product ID and a link to a first survey stored in the first server, to a first mobile computing device, and electronic receipt data of the first type that includes a second product ID and a link to a second survey stored in the first server, to a second mobile computing device, and
the second server retrieves the first survey from the first server using the first product ID received from the first mobile computing device that received the electronic receipt data and accessed the first survey, and the second survey from the first server using the second product ID received from the second mobile computing device that received the electronic receipt data and accessed the second survey.

5. The system according to claim 1, wherein
the first server receives the completed surveys transmitted from the mobile computing devices, through the second server.

6. A method for collecting information about a plurality of products, comprising:
storing a plurality of surveys, each being correlated to a product ID;
storing electronic receipt data generated by and transmitted from a plurality of store servers in connection with purchase transactions of products;
transmitting, to a plurality of mobile computing devices, electronic receipt data of a first type that includes a link to a survey and electronic receipt data of a second type that does not include the link;
receiving a survey request from a mobile computing device that received the electronic receipt data of the first type and activated the link;
responding to the survey request with a survey corresponding to a product ID included in the survey request; and
storing a completed survey transmitted from the mobile computing device that received the survey and indicated completion of the survey, in association with the product ID.

7. The method according to claim 6, wherein
the electronic receipt data of the first type is transmitted to the mobile computing devices when a product ID in the electronic receipt data is correlated with a survey, and
the electronic receipt data of the second type is transmitted to the mobile computing devices when no product ID in the electronic receipt data is correlated with a survey.

8. The method according to claim 6, further comprising:
generating a survey form using the stored survey, the survey form being transmitted to the mobile computing device that originated the survey request.

9. A system for collecting information about a plurality of products, comprising:
a first server that stores one or more questions about the products, each question being correlated to a product ID, and is configured to respond to a question request with a question form corresponding to a product ID included in the question request; and
a second server networked to a plurality of store servers and a plurality of mobile computing devices of users, the second server being configured to receive and store electronic receipt data generated by the store servers in connection with purchase transactions of products, and to transmit electronic receipt data of a first type that includes a link to a question form stored in the first server and electronic receipt data of a second type that does not include the link,
wherein the first server receives completed questions transmitted from each of the mobile computing devices that received the electronic receipt data of the first type, accessed one of the question forms stored in the first server through the link, and then indicated completion of the question.

10. The system according to claim 9, wherein
the second server stores a table including product IDs for which users can ask questions is available,
the electronic receipt data of the first type is transmitted to the mobile computing devices when a product ID in the electronic receipt data is included in the table, and
the electronic receipt data of the second type is transmitted to the mobile computing devices when no product ID in the electronic receipt data is included in the table.

11. The system according to claim 10, wherein
the second server receives the product IDs corresponding to products about which users can ask questions, from the first server.

12. The system according to claim 9, wherein
the second server transmits electronic receipt data of the first type that includes a first product ID and a link to a first question form stored in the first server, to a first mobile computing device, and electronic receipt data of the first type that includes a second product ID and a link to a second question form stored in the first server, to a second mobile computing device, and
the second server retrieves the first question form from the first server using the first product ID received from the first mobile computing device that received the electronic receipt data and activated the link to the first question form, and the second question form from the first server using the second product ID received from the second mobile computing device that received the electronic receipt data and activated the link to the second question form.

13. The system according to claim 9, wherein
the first server receives the completed questions transmitted from the mobile computing devices, through the second server.
